(19) United States
(12) Patent Application Publication
(10) Pub. No.: US 2007/0185726 A1
(43) Pub. Date: Aug. 9, 2007

(54) Methods and systems for processing suspicious delivery fee payment indicia

(76) Inventors: Vantresa S. Stickler, Annapolis, MD (US); Himesh A. Patel, Centreville, VA (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/521,441

(22) Filed: Sep. 15, 2006

Related U.S. Application Data
(63) Continuation of application No. 11/329,250, filed on Jan. 11, 2006, now abandoned.
(60) Provisional application No. 60/642,603, filed on Jan. 11, 2005.

(51) Int. Cl. G06Q 99/00; G06F 17/00

(52) U.S. Cl. 705/1; 705/410

(57) ABSTRACT

Methods and systems for detecting suspicious use of coded payment indicia on a delivery item, such as fraudulent IBI on a delivery item placed in the U.S. postal system and taking action triggered by the suspicion. Actions may include extracting the suspicious delivery item from the delivery process, recording images and gathering other information about the suspicious delivery item, and notifying, billing, or penalizing the sender of the suspicious delivery item.

### RELATED APPLICATION

This applications claims benefit of U.S. Provisional Application No. 60/642,603 filed Jan. 11, 2005, entitled “Methods and Systems for Detecting and Extracting Fraudulent IBI Mail,” which is incorporated herein by reference in its entirety.

### TECHNICAL FIELD

The invention relates generally to a system and method for detecting and resolving suspicious use of delivery fee payment indicia, and more particularly, to acting upon fraudulent use of an information-based delivery fee payment indicia on a delivery item.

### BACKGROUND

Delivery services (e.g., the U.S. Postal Service, UPS™, etc.) deliver items (e.g., letters, packages, magazines, etc.) for a delivery fee, generally referred to as “postage.” The postage may be paid or represented in the form of delivery fee payment indicia, such as coded marks printed on the delivery item (or a label affixed to the item), or in the form of a postage stamp on the delivery item. The payment indicia or postage stamp shows delivery service personnel and equipment that the postage has been paid for the delivery item, and that delivery processing should proceed for the item. One type of payment indicia includes a bar-code printed on a delivery item or printed on a label affixed to a delivery item, such as an envelope containing a letter. For example, FIG. 1 shows examples of digital postage marks, called “information based indicia” (IBI), used by the U.S. Postal Service (USPS) to indicate payment of delivery fees (postage) for an item.

As shown, IBI postage markings may be printed directly on a delivery item 110, or printed on a label 120 that may be affixed to a delivery item. Generally, IBI include a barcode 130 that contains mail-processing and security-related data. IBI typically employ a machine-readable two-dimensional barcode 130 to encode security and mail processing information, for example, in a PDF 417 or Data Matrix barcode format.

As shown, IBI may also contain human-readable information 140 to show, for example, mailing date, postage amount, postage meter device information, etc.

A delivery service may desire to monitor the usage of payment indicia to determine if customers and users are properly using the indicia. This may include checking that customers or users are not fraudulently or mistakenly misusing payment indicia for sending delivery items, for example, by photocopying an indicia label and affixing the copies to several delivery items, or by creating payment indicia representing postage for a one-ounce delivery item and placing the indicia on a five-ounce item. In addition, this may include checking to see if the indicia are being correctly used and accounted for by the delivery system. Mistaken or fraudulent use and improper accounting of coded postage indicia can reduce the revenue of a delivery service and increase costs for all users of the delivery service.

In some applications, a delivery service may draw a sample from a large batch of IBI-encoded mail deposited at an origin acceptance unit by a large mailer, such as a catalog company, and test the sample for compliance with postal regulations. If the sample appears to be acceptable, then the entire large batch is accepted and placed into the delivery system. If in reality other portions of the batch do not meet the postal regulations, the delivery service may not discover the problem and thus may not recover any postage underpayment.

In the U.S. Postal Service, revenue protection and postage fraud detection and protection are responsibilities of the United States Postal Inspection Service (Inspection Service). Currently, the primary methods of alerting the United States Postal Inspection Service of suspicious IBI-encoded delivery items and mailers who use IBI in a potentially fraudulent manner are: 1) notification by clerks and carriers who handle the mail, and 2) notification by the Origination-Destination Investigation System (ODIS) program. In both cases, the detection and notification process may be manually applied to only a limited sampling of mail with IBI postage, and any suspicious delivery items generally cannot be diverted for further inspection, or other actions taken, before the item is delivered.

Thus, it is desirable to provide better and more efficient systems and methods for detecting and investigating delivery items for suspicious use of coded payment indicia, such as IBI and for detecting and extracting suspicious delivery items bearing coded payment indicia. It is desirable to provide systems and methods that overcome the limited sampling capabilities associated with manual investigation and to provide inspection departments with additional data and tools for analysis, investigation, and potential prosecution of coded payment indicia fraud.

### SUMMARY

Embodiments consistent with the invention provide methods and systems for detecting suspicious use of coded payment indicia on a delivery item, such as fraudulent IBI on a delivery item placed in the U.S. postal system and taking action prompted by the suspicion.

Embodiments include methods and systems for processing a delivery item having indicia, comprising operations and apparatus for receiving the delivery item into a delivery process; creating an image of the delivery item and indicia; decoding information related to the delivery item from the indicia; accessing information related to the delivery item from a data source other than the indicia; comparing the decoded information to the corresponding accessed information; flagging the delivery item as suspicious if the decoded information and the corresponding accessed information are different; and extracting the delivery item from the delivery process if the delivery item is flagged as suspicious.

Advantages of the invention will be set forth in part in the description which follows, and in part will be obvious from the description, or may be learned by practice of the invention. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments consistent with the invention and together with the description, serve to explain the principles of the invention.

FIG. 1 shows exemplary embodiments of coded payment indicia consistent with the invention;

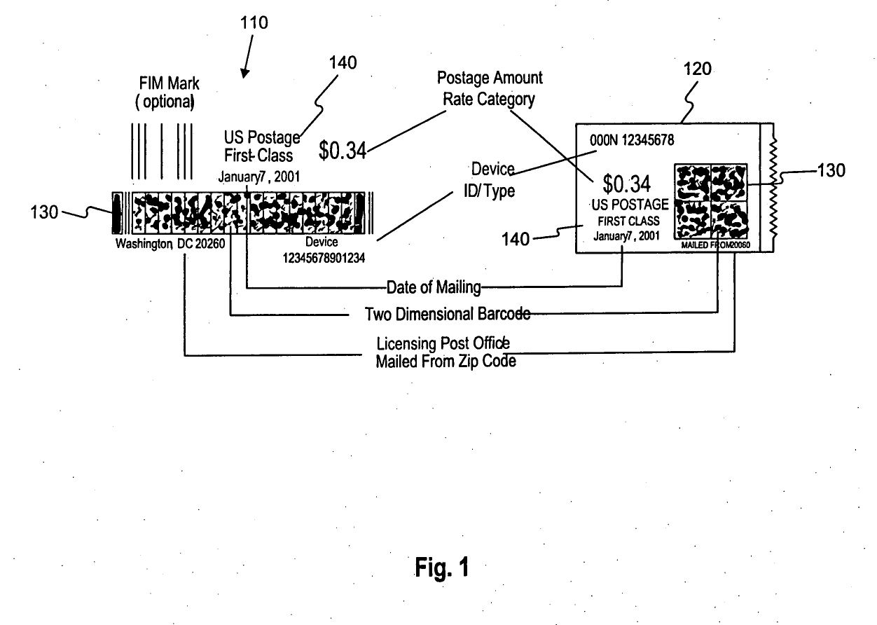

FIG. 2A is a flowchart of a method for detecting suspicious use of coded payment indicia consistent with the invention;

FIG. 2B is a flowchart of an exemplary method for processing suspicious delivery items having coded payment indicia, consistent with the invention;

FIG. 3 is an illustration of a system for detecting suspicious use of coded payment indicia consistent with the invention; and

FIG. 4 is a flowchart of a method for reacting to suspicious use of coded payment indicia consistent with the invention.

### DETAILED DESCRIPTION

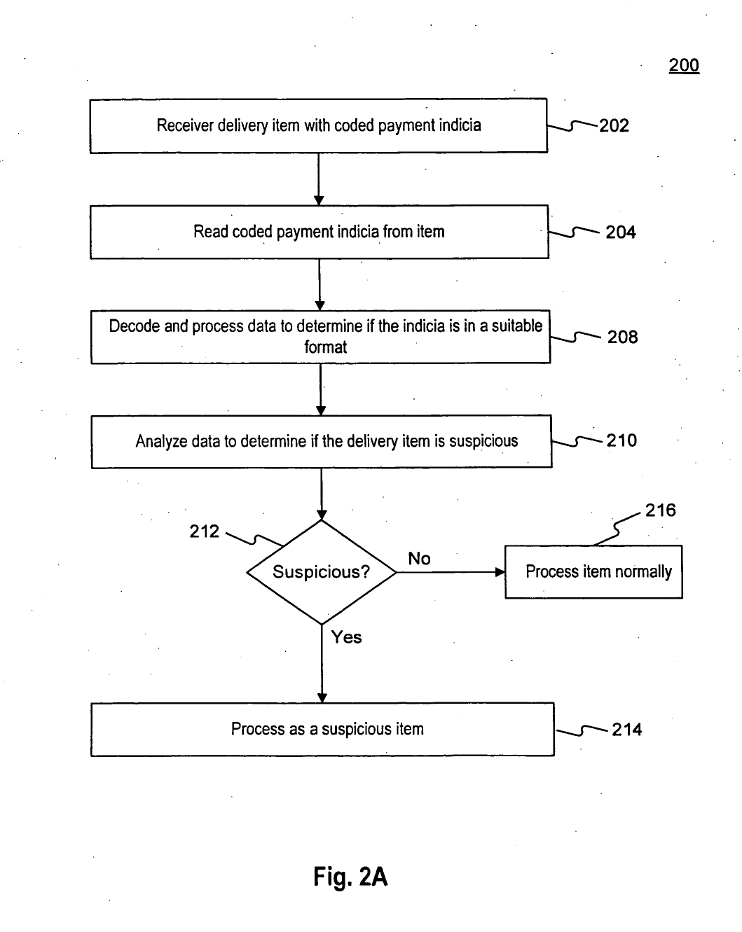

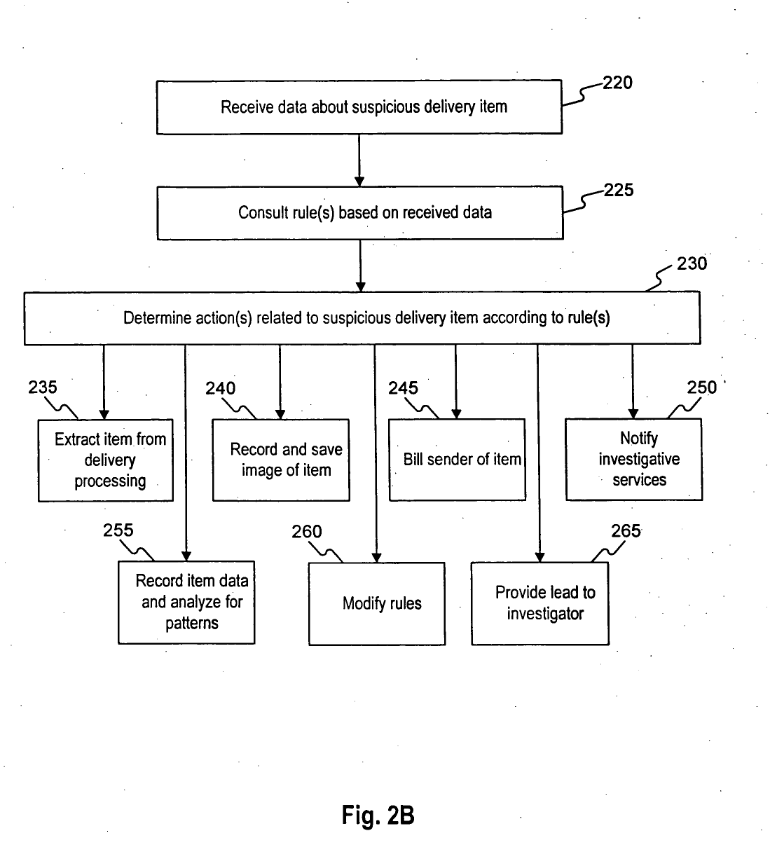

FIG. 2A is a flowchart of a method for detecting suspicious use of coded payment indicia consistent with the invention. As shown, at stage 202, a delivery item with a coded payment indicia is received from a customer or sender. For example, the USPS may receive a large batch of IBI encoded envelopes from a bulk mailer.

At stage 204, the coded payment indicia are read from the delivery item. This may be part of acceptance processing of a batch of delivery items, or it may happen during normal delivery processing. For example, in one embodiment, during delivery processing in a sorting machine, a camera system (e.g., a wide field of view (WFOV) camera system) may image the delivery item, including the coded payment indicia on the delivery item, and a computer in the camera system may locate, read, and locally store the indicia data. In another embodiment, a bar-code reader or scanner system may locate, read, and store the IBI data.

In one embodiment consistent with the invention, the data from the coded payment indicia may represent information about the sender, the device that created the indicia, the postage amount, the delivery destination, etc., because two-dimensional barcodes and similar technologies can represent a large amount of information in a small amount of space. In one embodiment, the camera system computer may execute an application that decodes the IBI markings into digital data and then stores and/or transfers the decoded digital data for further processing.

In another embodiment consistent with the invention, the data from the coded payment indicia may be associated or combined with other information about the delivery item bearing the indicia that comes from other sources. For example, information such as destination address, sender address, POSTNET™ code, PLANET™ code, ID code, item weight, time the item was scanned or imaged, location of the camera or scanner, machine type, operation performed, etc. may be collected from text, bar codes, or other sources of information on the delivery item, and from sorting machines, weighing machines, scanner systems, and other processing equipment and stored in association with the data from the coded payment indicia.

At stage 208, the coded payment indicia data is processed against a template to determine whether the coded payment indicia is valid and is in a suitable format. Indicia are valid if the resulting digital data is in a format consistent with a validator.

At stage 210, the coded payment indicia data is analyzed to determine suspicion of fraud, misuse, or mistake. Various algorithms may be used to determine whether a delivery item is suspicious. The algorithms may include algorithms for detecting coded payment indicia duplication or counterfeiting (e.g., check for multiple instances of the same indicia used on different items and for handwritten addresses), a tampered postage meter (e.g., validate that the sum of postage paid by processed coded payment indicia records does not exceed the postage recorded on the generating meter and that the ascending register of the meter is consistent with meter activity), lost/stolen/unlicensed postage meters (e.g., verify that a licensed, active meter generated the coded payment indicia on the delivery item), coded payment indicia forgery (e.g., validate coded payment indicia field level data against acceptable coded payment indicia field values, such as valid creation date, valid software ID, valid algorithm ID, valid destination ID, and valid digital signature, and check for intentionally unreadable (smudged, etc.) copies of indicia), short paid postage (e.g., identify transactions where the applied coded payment indicia postage is less than the minimum postage threshold for that delivery class, service, weight, etc.), indicia data that does not correspond to other data about the delivery item (e.g., validate coded payment indicia field level data against other known delivery item information, such as delivery address), and human readable data tampering (e.g., compare human readable information, which may be determined from an item's image using optical character reader technology, with the data available in the indicia, such as date, postage, and destination ZIP Code™ delivery code), among others. U.S. Pat. No. 6,527,178, which is assigned to the U.S. Postal Service and is hereby incorporated herein by reference in its entirety, describes some exemplary methods for detecting counterfeit indicia.

If the analysis determines that the delivery item is not suspicious (stage 212, No), then the delivery item undergoes normal processing and delivery (stage 216). If, on the other hand, the analysis determines that the delivery item is suspicious (stage 212, Yes), then the delivery item is processed as suspicious (stage 214).

FIG. 2B is a flowchart of an exemplary method for processing suspicious delivery items having coded payment indicia, consistent with the invention. As shown, at stage 220 the process begins with receiving data about the suspicious delivery item. This data may include, for example, delivery item data, scan event data, and operations data. Delivery item data (e.g. indicia data, ID tag data, etc.) is identical across multiple scans (i.e., imagings) of the same item as it passes through processing equipment, but the scan event and operations data (date/time, operation, etc.) will vary by each operation and machine on which the item is processed. For example, Table 1 shows exemplary data fields that may be associated with a delivery item processed by the USPS, and exemplary sources which gather the information used to populate the fields.

TABLE 1

| | |
|---|---|
| DATAELEMENTS | DATASOURCE |

MAILPIECE DATA

| | |
|---|---|
| IBI Barcode Decode | Wide Field of View Camera |
| Indicia Version Number | (WFOV) |
| Algorithm ID | |
| Certificate Serial Number | |
| Vendor ID | |
| Software ID | |
| PSD Model Number | |
| PSD Serial Number | |
| Ascending Register | |
| Descending Register | |
| Postage Value | |
| Mail Category/Class | |
| Date of Mailing or Indicia Creation | |
| Originating ZIP Code | |
| Destination ZIP Code | |
| Digital Signature | |
| POSTNET Code | WFOV Camera |
| PLANET Code 1 | WFOV Camera |
| PLANET Code 2 | WFOV Camera |
| ID Tag | ID Tag Reader |

SCAN EVENT/OPERATIONS DATA

| | |
|---|---|
| Scan Date/Time | Mail Processing Equipment |
| | (MPE) |
| Facility ID | MPE |
| Machine ID/Machine Type | MPE |
| Operation Code | MPE |
| Sort Bin | MPE |

In the embodiment shown in FIG. 2B, the process next consults predetermined processing rule(s) (discussed below) for processing the delivery item based on the received data about the item (stage 225). At stage 230, the suspicious delivery item is processed by one or more actions determined by rule(s) and the data related to the delivery item. In addition to the received delivery item data, other data and information, for example the stored history of use for a given coded payment indicia or for a given sender, may also be used by the rule(s) to determine the further action(s) to be taken.

One or more of the actions shown in stages 235-265 may be instituted, according to the rules set up for a given set of information about a suspicious delivery item.

For example, the rule(s) may dictate that if the delivery item bears coded payment indicia that has been identified several times on previously processed delivery items, then the deliver piece may be extracted for investigative and evidence purposes (stage 235). Physical evidence may be needed if a fraudulent use investigation requires follow-up with a licensee (sender) or legal action. Previous use of indicia is merely one example of a “trigger,” or criterion, for item extraction 235, and many other criteria may be set in the rules to initiate extraction of a suspicious delivery item. For example, in the final evidence-gathering phase of an investigation of a fraudulent sender, a rule may dictate that all delivery items with coded payment indicia indicating that they were produced by the fraudulent sender be extracted from the delivery stream.

In one embodiment, extraction may be done automatically by directing the machine currently processing the delivery item to sort the item into a special non-delivery bin. Similarly, a downstream processing machine that will handle the delivery item in the future may be directed to extract the item from the normal processing stream when it is processed.

In another embodiment, after determining the destination delivery unit that is expected to receive the delivery item, extraction may be done manually by delivery service personnel, such as a letter carrier, who is notified to watch for and retain the delivery item when they process it for delivery. For example, an “alert” message may be sent to a device being used by the letter carrier, such as a scanner, portable digital assistant (PDA), or other hand-held or vehicle-mounted device, instructing the delivery carrier to take specified actions, such as hold the delivery item and return it to the processing plant instead of delivering it. Personnel may also manually extract the suspicious delivery item from the processing machine (e.g. a sorting machine) that first detects the suspicious item (or elsewhere in the facility), if the delivery item has not yet been transferred to another facility.

In yet another embodiment, the method may also set processing equipment to “trap” future delivery items sent by the same sender so that such items are automatically or manually extracted from the delivery stream for closer scrutiny by investigative personnel, etc., searching for evidence of systematic fraud by the sender.

In some embodiments, stage 235 may be combined with other actions, such as issuing an alert to an investigative service 250, which may contact the sender, examine the extracted delivery item, scrutinize other items sent by the sender to detect additional problems, gather evidence of systematic fraud, etc.

As another possible action, the rule(s) may dictate that if the delivery item is suspicious according to predefined criteria, information related to the delivery item is recorded and analyzed (stage 255). In one embodiment, the item's information is analyzed with recorded information from other suspicious items to detect patterns, trends, locations, etc. that may indicate fraud, misuse, common mistakes, etc. associated with delivery items having coded payment indicia. Such analysis may be done by computer applications, investigative department personnel, or both. As with all actions, this action may be combined with other actions, such as modifying the suspicious item detection rules 260 by modifying rule thresholds based on patterns, trends, etc. discovered in analysis of large bodies of data.

As another possible action, the rule(s) may dictate that if the delivery item is suspicious in some way, images of the delivery item are recorded and stored (stage 240). For example, the initial image used to read the coded payment indicia may be moved to a special storage area or database. In another example, downstream delivery item processing equipment, such as a destination sorting machine, may be directed to automatically capture and store an image of the suspicious item when the item is processed. In one embodiment, after determining the suspicious item's delivery destination, a message may be sent to a device being used by the delivery carrier scheduled to finally deliver the item, such as a scanner, portable digital assistant (PDA), or other hand-held or vehicle-mounted device, instructing the delivery carrier to record an image of the item before delivering it. In such an embodiment, the hand-held device may include a camera for recording an image of the delivery item and a coded payment indicia application that sends the image to a network computer for storage, further investigation, trend analysis, etc.

As another possible action, the rule(s) may dictate that if the delivery item is suspicious in a specified way, then the rules are modified to flag more or fewer items with characteristics similar to those of the suspicious item (stage 260). For example, if items are flagged as suspicious because they are overweight by 0.05 ounce or more, but the 0.05 ounce threshold causes too many coded payment indicia items (e.g., more than 15 percent) to be flagged as suspicious (e.g., due to the inaccuracy or precision of weighing equipment), then the rule threshold may be adjusted to reduce false positives. In this example, the overweight threshold may be changed to overweight by 0.1 ounce or more to be flagged as a suspicious item. As mentioned, this action may be combined with other actions, such as analysis of suspicious item data 255 to determine patterns, trends, etc., which may, for example, identify false positive trends for certain item parameters.

In another example or modifying rules (stage 260), the analysis and notification rules may be user-modified to alert relevant inspectors of a new or continually developing pattern of suspicious delivery items having coded payment indicia. In an initial phase, notification alerts may be focused on the results of post-event analysis and may prompt the investigative personnel to actively investigate. As preventable patterns are identified, the rules may be modified to make more focused on prompting immediate actions, such extracting a batch of suspicious mail currently being processed, etc.

As another possible action, the rule(s) may dictate that if the coded payment indicia and delivery item weight information indicate that the sender associated with the delivery item has underweight postage beyond a threshold (for example, three times previously, or $20.00 total underpayments), then the sender is billed for the underpayment or the sender's account is debited the underpaid amount (stage 245). As mentioned, this action may be combined with other actions, such as issuing an alert to an investigative service, which may contact the sender or scrutinize other items sent by the sender to detect additional problems, gather evidence of systematic fraud, etc. In addition to the example of underweight postage, other criteria may be set in the rules to trigger billing of a sender of suspicious items. For example, a rule may dictate that a sender be billed for affixing indicia with the wrong class to a delivery item (e.g., third class postage indicia on a first class delivery item).

As another possible action, the rule(s) may dictate that if the delivery item is suspicious in a specified way, then an investigative service is notified (stage 250). In one embodiment, this allows specified delivery service personnel to be notified practically immediately when certain suspicious items have been detected or customized thresholds have been met. As noted above, notification of personnel also provides a near real-time method to identify delivery items and extract them if desired as they pass through the delivery processing stream. Notification may be implemented with alert messages sent via email, pager, text message, voice messaging, public address system announcement, etc. The exact notification implementation used is not critical to the invention.

As another possible action, the rule(s) may dictate that if the delivery item is suspicious in a specified way, then a “lead” is provided to a field investigator (stage 265). In one embodiment, a lead includes a notification to a specific investigator(s) and information linking the notification to supporting data for a new or established formal investigation. The additional analysis and information documented in the lead may support an already active investigation and help accurately track the formal investigation “trail.” The specifically involved field investigator may be in a position to more effectively act upon the information than the recipient(s) of a general notification to an investigative service 250. In one embodiment, a lead allows specific investigators to be notified essentially immediately when certain suspicious items have been detected, customized thresholds have been met, or certain analyses reach a specified determination that require a more formalized investigation level than a general alert might generate. As noted above, notification of personnel also provides a near real-time method to identify delivery items and extract them if desired as they pass through the delivery processing stream. Similar to an alert notification, a lead may be implemented via email, pager, text message, voice messaging, file sharing, etc. The exact lead implementation used is not critical to the invention.

One of ordinary skill in the art will recognize that, in addition to the examples mentioned, many other actions may be taken to collect data regarding, analyze, investigate, and obtain suspicious delivery items having coded payment indicia without departing from the scope of the invention. For example, suspicious items may be returned to the sender marked for insufficient postage, if applicable. For another example, the sender's postage account or online indicia-generation privileges may be suspended. For yet another example, a form letter may be automatically generated and sent to the sender warning of an apparent problem with, or misuse of, the sender's indicia-generating equipment. One of ordinary skill in the art will also recognize that the processes described in FIGS. 2A and 2B may have stages added, deleted, modified, reordered, etc. without departing from the scope of the invention.

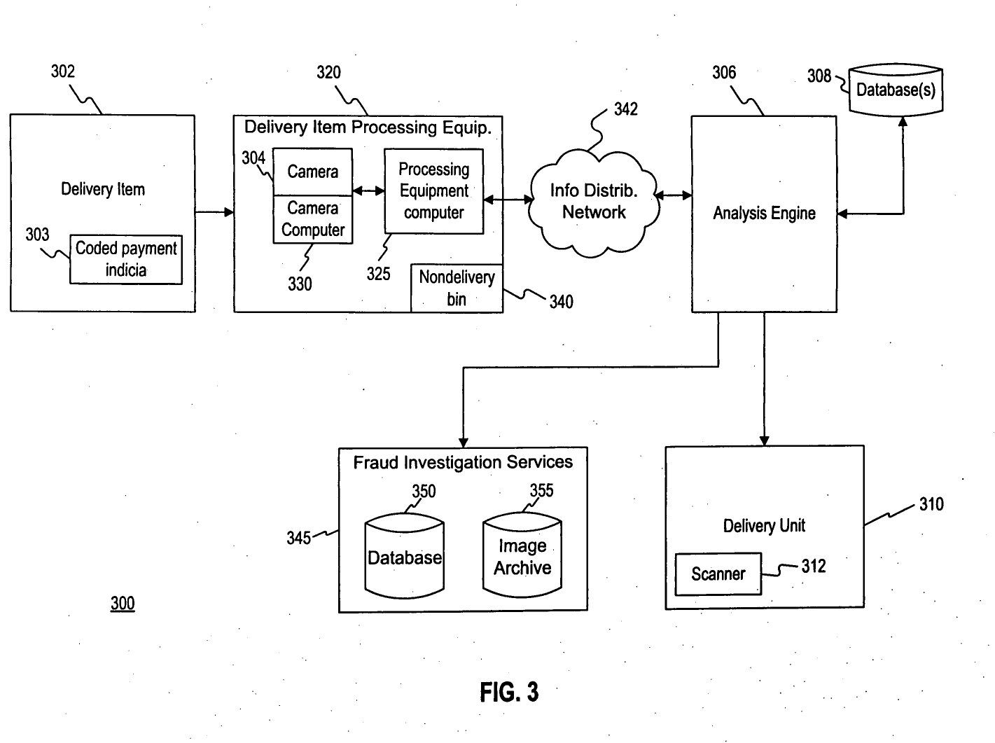

FIG. 3 is an illustration of an exemplary system 300 for detecting suspicious use of coded payment indicia consistent with the invention. For example, such a system may be used to implement the processes shown in FIGS. 2A and 2B. As shown in FIG. 3, system 300 receives a delivery item 302 having coded payment indicia 303, such as a two-dimensional bar code. System 300 includes a delivery item processing equipment 320, for example, a package sorting machine at a UPS™ facility. Delivery item processing equipment 320 includes a camera system comprising a camera 304 connected to a camera computer 330, which controls the camera's operations and performs communications and other functions. Delivery item processing equipment 320 also includes a processing equipment computer 325, which controls the processing equipment's operations, communicates with camera computer 330, and performs external communications and other functions. Delivery item processing equipment 320 also includes a nondelivery bin 340, which may be a standard sorting bin designated to accept delivery items that are not to undergo normal delivery processing. Computer-controlled delivery item processing equipment with camera systems and programmable sorting capabilities are known in the art and the exact configuration used is not critical to the invention.

As shown, processing equipment computer 325 is communicatively connected to an analysis engine 306 via an information distribution network 342. Network 342 may include a private LAN, a private WAN, and/or public networks, such as the Internet. Although not shown, information distribution network 342 is preferably connected to other delivery item processing equipment, in both the same facility and remote facilities. The exact network implementation used is not critical to the invention. Analysis engine 306 may include a software application running on a workstation or server, or it may be implemented in hardware or firmware. Analysis engine 306 may also include high-capacity local data storage devices. The exact implementation is not critical to the invention, as long as it provides the claimed functionality.

In the embodiment shown, analysis engine 306 is communicatively connected to a database(s) 308. Database 308 represents sources of data used by analysis engine 306. In one embodiment, database 308 includes a repository of information (e.g. standards, field definitions, etc.) regarding coded indicia, such as coded payment indicia 303. In another embodiment, database 308 includes a repository of data regarding sender-generated payment indicia, such as that generated by a postage meter. In other embodiments, the information in database 308 may be included in data structures in analysis engine 306 or stored in some other fashion.

As shown, analysis engine 306 is also communicatively connected to a delivery unit 310. In another embodiment, analysis engine 306 may be communicatively connected to delivery unit 310 via information distribution network 342. In one embodiment, delivery unit 310 is a destination or intermediate facility that processes delivery item 302 after it is processed by delivery item processing equipment 320. Delivery unit 310 may include its own computer-controlled delivery item processing equipment, similar to delivery item processing equipment 320. Delivery unit 310 includes a scanner 312. Scanner 312 may be similar to camera 304 and camera computer 330 of a computer-controlled delivery item processing equipment, or it may be a handheld scanner or camera, or part of a handheld device such as a PDA or camera cell phone, that equips a carrier who delivers an item to its final addressed destination, such a USPS mail carrier.

As shown, analysis engine 306 is also communicatively connected to a fraud investigation services 345. In another embodiment, analysis engine 306 may be communicatively connected to fraud investigation services 345 via information distribution network 342. In one embodiment, fraud investigation services 345 includes personnel and equipment for postage fraud or mistake detection, prevention, and remedy (including legal action), such as the United States Postal Inspection Service. Fraud investigation services 345 may include a database 350 and an image archive 355 that may be used to hold data, information, and images related to suspicious delivery items having coded payment indicia.

In one implementation consistent with the invention, a sender places coded payment indicia 303 on delivery item 302, representing that the proper delivery fee has been paid for delivering delivery item 302, and enters delivery item 302 into a delivery process operated by a delivery service (e.g., the U.S. Postal Service, UPS™, DHL™, FedEx™, Emory™ etc.). During initial processing stages, camera 304 of delivery processing equipment 320 scans or images delivery item 302, including coded payment indicia 303. Camera computer 330 detects and decodes indicia 303, and temporarily stores the digital information represented by indicia 303. Information associated with indicia 303 may include the amount of fees paid for delivery, delivery destination information, and tracking information that uniquely identifies delivery item 302, among other things. Table 1 shows an example of a set of indicia information. Camera 304 and camera computer 330 may also image and decode other delivery item information, such as one-dimensional barcodes and text. For example, USPS processing equipment typically captures and decodes PLANET™ and POSTNET™ codes from delivery items.

Camera computer 330 sends the information decoded from indicia 303, and other information such PLANET™ and POSTNET™ code information, to processing equipment computer 325. In one embodiment, processing equipment computer 325 combines the information about delivery item 302 from camera computer 330 with corresponding information from the processing equipment, such as ID tag data, scan event data, and operations data. Processing equipment computer 325 transmits the information about delivery item 302 to analysis engine 306 via information distribution network 342.

In one embodiment, after receiving the delivery item data, analysis engine 306 stores and analyzes the data to determine whether delivery item 302 is suspicious. For example, analysis engine 306 may execute a series of algorithms that identify suspicious, potentially fraudulent patterns and the specific indicia-bearing delivery items that contributed to them. As noted with regard to FIGS. 2A and 2B, such algorithms may identify coded payment indicia duplication or counterfeiting, tampered postage meters, lost/stolen/unlicensed postage meters, coded payment indicia forgery, short paid postage, indicia data that does not correspond to other data about the delivery item, and indicia data that does not correspond to human readable data, among other things.

Database 308 may include a repository of information regarding coded indicia, including coded payment indicia 303 and may include a repository of information regarding customer (e.g., sender meter) generation of coded indicia. Analysis engine 306 may use information from database 308 to determine whether a delivery item is suspicious. For example, using the latest information regarding coded indicia from database 308, analysis engine 306 may execute an algorithm to determine whether the data from coded payment indicia 303 was from an appropriate barcode construction. If the barcode data was improperly formatted, then the algorithm may flag delivery item 302 as suspicious. Similarly, using the latest information regarding postage meter status from database 308, analysis engine 306 may execute an algorithm to determine whether coded payment indicia 303 was printed by a stolen postage meter. If so, then the algorithm may flag delivery item 302 as suspicious.

If analysis engine 306 determines that delivery item 302 is suspicious, it may implement or trigger an action, or combination of several actions, such as those shown in FIG. 2B. For example, analysis engine 306 may communicate with delivery item processing equipment 320 via information distribution network 342 and direct delivery item processing equipment 320 to sort delivery item 302 into nondelivery bin 340 and further notify fraud investigation services 345 to have someone retrieve delivery item 302 from nondelivery bin 340 for further investigation. Similarly, analysis engine 306 may determine that delivery item 302 is destined for delivery unit 310 and communicate with delivery unit 310 to direct delivery item processing equipment located at delivery unit 310 to sort delivery item 302 into a nondelivery bin. Similarly, analysis engine 306 may send an alert message to scanner 312 of a delivery carrier responsible for delivering delivery item 302 instructing the carrier to hold deliver item 302 to prevent delivery, or to photograph deliver item 302 before delivery and forward the image to fraud investigation services 345. For yet another example, analysis engine 306 may communicate data and images for deliver item 302 to fraud investigation services 345 for storage in database 350 and image archive 355 as part of a new or ongoing investigation.

One of ordinary skill in the art will recognize that the system shown in FIG. 3 may have components added, deleted, modified, consolidated, etc. without departing from the scope of the invention.

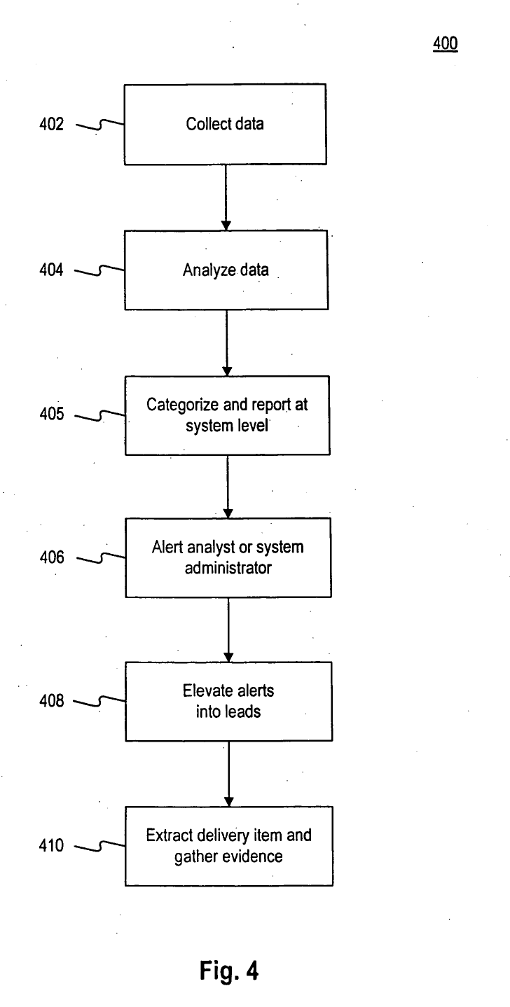

FIG. 4 illustrates a flowchart of method 400 for reacting to suspicious delivery payment indicia consistent with one embodiment of the present invention. As shown, method 400 begins at stage 402 with collecting data related to a delivery item, including coded indicia data such as IBI data from a USPS WFOV camera, data regarding processing of the delivery item, such as data from USPS mail handling equipment (e.g., ID Tag and scan event data), and data regarding generation of the coded indicia, such as USPS National Meter Account Tracking System (NMATS) data regarding postage meter activity and licensing.

At stage 404, the collected data is analyzed to detect suspicious delivery items. The data is also compiled and organized in conjunction with previously stored data regarding other suspicious delivery items to identify potential fraud, mistake, or misuse trends related to delivery items bearing coded indicia.

At stage 405, the collected data is reported at a system level to an analyst(s). This system-level report may summarize and categorize the data that was evaluated through the delivery item analysis processing. In one embodiment, analysts will also have access to the ad-hoc reporting capability to evaluate summarized data differently from the system-generated reports.

In one embodiment consistent with the invention, using the system level reports, the analyst creates or revises the rules and/or thresholds that trigger actions in response to detecting suspicious delivery items, such as the actions shown in FIG. 2B. The analyst may thus customize the search for suspicious items, gradually escalate the responding actions, and “train” the system to find instances of fraud and mistake that are worth the resources needed to investigate and resolve them.

At stage 406, the system alerts or notifies the analyst according to the customized rules and thresholds set by the analyst.

After gathering a more focused set of data based on the alerts, the analyst may again create or revise rules and/or thresholds that trigger actions in response to detecting suspicious delivery items, elevating specified alerts or notifications into leads, which are tied to a formal investigation of a fraudulent mailpiece and other activity associated with that mailpiece (stage 408).

After gathering an even more focused set of data based on the leads generated by the customized rules, as well as any additional information gathered by the formal investigation, the analyst may again create or revise rules and/or thresholds that trigger actions in response to detecting suspicious delivery items, and cause delivery items meeting the investigation's criteria to be extracted from the delivery stream (stage 410). The extracted items may be used as physical evidence for further investigation or legal action.

In one embodiment, method 400 may be implemented using a general purpose computer and software, such as is consistent with one embodiment of analysis engine 306 of system 300 shown in FIG. 3.

One of ordinary skill in the art will recognize that the process described in FIG. 4 may have stages added, deleted, modified, reordered, etc. without departing from the scope of the invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for processing a delivery item having indicia, comprising:
receiving the delivery item into a delivery process;
creating an image of the delivery item and the indicia;
decoding information related to the delivery item from the indicia;
accessing information related to the delivery item from a data source other than the indicia;
comparing the decoded information to the corresponding accessed information;
flagging the delivery item as suspicious if the decoded information and the corresponding accessed information differ according to a specified criterion; and
extracting the delivery item from the delivery process if the delivery item is flagged as suspicious.

2. The method of claim 1, wherein extracting comprises:
providing information identifying the delivery item to a delivery item processing machine;
directing the delivery item processing machine to sort the delivery item into a specified bin after identifying the delivery item using the provided information.

3. The method of claim 1, wherein extracting comprises:
identifying a delivery item processing machine that will process the delivery item in the future according to the delivery process;
providing information identifying the delivery item to the identified delivery item processing machine;
directing the identified delivery item processing machine to sort the delivery item into a specified bin after identifying the delivery item using the provided information.

4. The method of claim 1, wherein extracting comprises:
formulating a message, including information identifying the delivery item, directing manual removal of the delivery item from the delivery process; and
transmitting the message to a device associated with a person able to manually extract the delivery item from the delivery process.

5. The method of claim 1, wherein extracting comprises:
determining a location where the delivery item will be in the future according to the delivery process;
formulating a message that directs manual removal of the delivery item from the delivery process, the message including information identifying the delivery item, the determined location and a time in the future when the delivery item will be at the location;
transmitting the message to a device associated with a person able to manually extract the delivery item from the delivery process at the determined location.

6. The method of claim 1, further comprising:
extracting a plurality of delivery items that are similar to the suspicious delivery item from the delivery process according to a specified criterion.

7. The method of claim 6, wherein extracting a plurality of delivery items comprises:
identifying a second delivery item that enters the delivery process after the delivery item flagged as suspicious, the second delivery item including decoded information similar, according to a specified criterion, to the decoded information of the delivery item flagged as suspicious; and
extracting the second delivery item from the delivery process.

8. A method for processing a delivery item having indicia, comprising:
receiving the delivery item into a delivery process;
creating an image of the delivery item and indicia;
decoding information related to the delivery item from the indicia;
accessing information related to the delivery item from a data source other than the indicia;
comparing the decoded information to the corresponding accessed information;
flagging the delivery item as suspicious if the decoded information and the corresponding accessed information differ according to a specified criterion; and
determining a sender of the suspicious delivery item using at least one of the decoded information and the accessed information; and
contacting the sender of the delivery item.

9. The method of claim 8, wherein:
comparing the decoded information to the corresponding accessed information comprises comparing a paid delivery fee indicated by the decoded information to a delivery fee determined from the accessed information; and
contacting the sender of the delivery item comprises debiting an amount equal to the difference between the paid delivery fee and the determined delivery fee from an account associated with the sender.

10. The method of claim 8, wherein contacting the sender of the delivery item comprises:
returning the delivery item to the sender.

11. The method of claim 8, wherein contacting the sender of the delivery item comprises:
suspending a privilege of the sender related to the delivery process.

12. A system for processing a delivery item, comprising:
a sorting machine for sorting the delivery item, the sorting machine including a camera for reading indicia on the delivery item and a computer for controlling operation of the sorting machine; and
an analysis engine, communicatively connected to the computer, comprising:
a component for receiving data associated with the indicia, analyzing the data to determine whether the delivery item is suspicious, and providing instructions to the computer; and
a component for, if the delivery item is determined to be suspicious, transmitting instructions to the computer identifying the delivery item for extraction,
wherein the computer comprises a component for, after receiving the transmitted instructions, controlling operation of the sorting machine so as to sort the delivery item to a specified location.

13. The system of claim 12, wherein the specified location is a nondelivery bin.
